(19) United States
(12) Patent Application Publication
(10) Pub. No.: US 2011/0183100 A1
(43) Pub. Date: Jul. 28, 2011

(54) SOLVENT-FREE ADHESIVE FOR WATERPROOF SHEET, WATERPROOF SHEET AND MANUFACTURING METHOD OF WATERPROOF SHEET USING THE SOLVENT-FREE ADHESIVE AND CONSTRUCTION METHOD USING THE WATERPROOF SHEET

(76) Inventors: Dae-Woo Lee, Gyeonggi-do (KR); Sang-Yun Lee, Gyeonggi-do (KR); Young-Geun Kim, Gyeonggi-do (KR)

(21) Appl. No.: 12/999,027

(22) PCT Filed: May 8, 2009
(86) PCT No.: PCT/KR09/02412

§ 371 Date: Jan. 20, 2011

(30) Foreign Application Priority Data
May 9, 2008 (KR) 10-2008-0043507
Mar. 20, 2009 (KR) 10-2009-0023829

(51) Int. Cl. B32B 7/12; C08L 25/10; B32B 5/02; B32B 37/02; B32B 37/08; B32B 37/12; B32B 37/14; B32B 38/10

(52) U.S. Cl. 428/41.8; 524/575; 428/355 BL; 442/149; 442/1; 156/60; 156/327; 156/249; 156/334

(57) ABSTRACT

Provided are a solvent-free adhesive for a waterproof sheet, a waterproof sheet and a manufacturing method of the waterproof sheet using the solvent-free adhesive, and a construction method using the waterproof sheet. The solvent-free adhesive is manufactured by mixing rubber and tackifier with heated oil in a heat liquefying mixer to form a mixture and thereafter mixing at least one additive with the mixture, wherein the oil is at least one of mineral oil, vegetable oil, and synthetic oil. The solvent-free adhesive is coated on a polymeric synthetic film sheet (e.g., PP, PE, PVC, EVA, and urethane) not having adhesive property.

### TECHNICAL FIELD

The present disclosure relates to a solvent-free adhesive for a waterproof sheet, a waterproof sheet and a manufacturing method of the waterproof sheet using the solvent-free adhesive, and a construction method using the waterproof sheet, and more particularly, to a solvent-free adhesive for a waterproof sheet, a waterproof sheet and manufacturing method of waterproof sheet using the solvent-free adhesive, and a construction method using the waterproof sheet by using an improved polymeric synthetic resin film sheet (e.g., PP, PE, PVC, and urethane that have not be used as waterproof material due to their lack of adhesiveness). The polymeric synthetic resin film sheet has excellent physical properties in terms of tensile strength, tear resistance, expansion coefficient, chemical resistance such as acid resistance and alkali resistance, and water-resistance.

### BACKGROUND ART

Liquefied asphalt, which is pitch, has been used to prevent water leakage and submergence of civil or building structures since the Middle Ages.

In the modern era, the construction and civil engineering industries have progressed significantly in the building of subways, multistory buildings, underground passages, underground shopping centers, and common-use channels to meet civil requirements. However, civil and building structures are still damaged by water leakage and submergence, resulting in short service life of structures and property loss. Accordingly, waterproofing that can be perfectly sustained from construction to removal of the structure is highly coveted by the construction industry.

Waterproofing materials, including liquefied asphalt, asphalt sheets, liquefied paint films, rubber sheets, and composite sheets, have been developed to improve upon the limitations accompanying related art waterproofing materials. Research and development is currently being conducted to obtain new forms of waterproofing material that are cost effective and completely waterproof.

In the past, cohesive and dense liquid asphalt was coated on areas of building structures that are prone to water leakage. Asphalt was re-coated upon water leakage recurrence. It is difficult to obtain effective waterproofing, however, by simply applying liquid asphalt on civil and building structures.

Asphalt is by no means inferior to other waterproofing materials because it is inexpensive, waterproof, and convenient to apply with brushes and rollers. However, in order to apply cohesive and dense liquid asphalt, asphalt must first be melted by applying heat, and can then be applied with a brush or roller. Asphalt liquefaction generates extremely toxic fumes and smoke, which impair waterproofing works. Also, it is difficult to form a uniformly-thick waterproof layer of boiled asphalt on a structure with an uneven surface because liquid asphalt tends to flow downward from surface projections.

While various liquid waterproofing materials including asphalt can be applied extensively and continuously without the use of joints, liquid waterproofing materials require several applications in order to form a waterproof layer with a uniform thickness ranging from about 1 mm to about 2 mm because the volume of a single coat of liquid waterproofing material contracts to a thickness ranging from about 0.2 mm to about 0.4 mm due to volatilization of its oil and solvent content.

Since oil and solvent take from about 5 hours to about 6 hours to dry after one application, soil or dust can adhere to the applied surface, causing separation between waterproof layers. Also, when waterproofing film coating is applied on concrete surfaces, bubbles or air pockets may be formed.

In order to solve the above limitations, asphalt sheet waterproofing material with a small amount of rubber resin added was introduced. When this was found to have limitations, the use of vulcanized rubber sheet waterproofing material composed primarily of rubber was attempted—which was not without its own drawbacks. A current industry trend in waterproofing is the use of various sheet-configuration waterproofing materials (including asphalt-coated polymeric synthetic resin film sheets), instead of the waterproofing coating film materials of the past. Sheet waterproofing material, however, must be joined with joints that are unreliable.

Sheet waterproofing material allows for a uniformly-thick waterproof layer that can be factory manufactured with a thickness ranging from about 1 mm to about 3 mm. During the process of connecting asphalt sheets when working with sheet waterproofing material, a heating device such as a torch or burner is used to melt asphalt. However, defects, in the form of weak adherence of a sheet (from insufficient heat applied) and hole formation in a sheet (from excessive heat applied), can occur, causing water leakage or submergence. To solve these limitations, rubber sheet waterproofing material was developed due to its excellent physical properties, including high tensile strength, tear resistance, expansion coefficient, acid-resistance, and alkali-resistance, that make it more favorable than the asphalt sheet. Additionally, rubber sheets do not require heat to be melted and joined with one another, and can be joined at normal outdoor temperatures by being connected and coated with a rubber primer dissolved in organic solvent. However, in addition to being very expensive, rubber sheets are very odorous and present a dangerous fire hazard due to the organic solvent.

Recently, a composite waterproofing material with asphalt adhered to a polymeric synthetic resin film sheet has emerged. However, because the composite waterproofing material also requires a heating device (a torch or burner) to join the polymeric synthetic resin film sheets, it has similar limitations to the above asphalt sheet.

Asphalt melts easily in hot summer temperatures, and becomes hard and brittle in cold winter temperatures. In consideration of these asphalt properties, manufacturers of asphalt sheet waterproofing material add a small amount of an expensive arborescent rubber such as Styrene Butadiene Styrene (SBS), or Styrene Isoprene Styrene (SIS) to asphalt. The present inventor has filed Korean Patent Application No. 10-1993-13474, entitled “PREPARATION OF WATER-PROOF SHEET USING THE SOLUBILIZATION OF RUBBER”, which discloses a method for manufacturing an asphalt sheet by dissolving natural rubber and Styrene Butadiene Rubber (SBR) in asphalt. However, the method also requires a heating device (e.g., a torch or a burner) to adhere connected sheets—similar to the case of the related art asphalt sheet.

After improving the above patent, the present inventor also filed Korean Patent Application No. 10-1995-0010382, entitled “MANUFACTURING METHOD OF WATERPROOF SHEET FOR ASPHALT”, which discloses a method for manufacturing a rubberized asphalt sheet by adding and mixing an additive (e.g., an adhesive and filler) and asphalt to rubber in an airtight Banbury mixer or a kneader under cooled conditions, instead of dissolving rubber in heated asphalt.

The rubberized asphalt is manufactured under cooled conditions, instead of the method of manufacturing a related art asphalt sheet that employs boiling asphalt. Accordingly, the rubberized asphalt shows the unique properties of rubber and asphalt, and sheets can be joined easily by simply applying primer to the joints.

While the related art asphalt sheets are joined with heat from a heating device such as a torch or burner, the asphalt sheets designed by the present inventor are joined at normal outdoor temperatures by applying primer without heating. Nevertheless, water leakage and submergence occurred at a joint between asphalt sheets designed by the present inventor.

In line with its current mandate for effective construction at lower cost, the construction industry is in want of less expensive, yet completely effective waterproofing material.

### DISCLOSURE OF INVENTION

### Technical Problem

The present disclosure provides a solvent-free adhesive for a waterproof sheet, a waterproof sheet and a manufacturing method of the waterproof sheet using the solvent-free adhesive, and a construction method using the waterproof sheet, which can enhance adhesive property of the waterproof sheet and enable more convenient waterproofing construction.

The present disclosure also provides a method of manufacturing a waterproof sheet using a solvent-free adhesive that can restrain an excessive increase of the equipment cost and simultaneously maximize yields per hour by reducing facilities for manufacturing the waterproof sheet.

The present disclosure also provides a waterproof sheet and a manufacturing method of the waterproof sheet using a solvent-free adhesive, which can be conveniently and effectively used for a waterproofing of concrete structures such as walls and floors of underground structures, walls and floors of building, and underground roadways.

The present disclosure also provides a solvent-free adhesive for a waterproof sheet, a waterproof sheet and a manufacturing method of the waterproof sheet using the solvent-free adhesive, using a polymeric synthetic resin film sheet such as PP, PE, PVC, EVA, and urethane as a waterproofing material.

The present disclosure also provides a method of constructing a waterproof sheet using a solvent-free adhesive, which can reduce a construction cost and have an improved waterproof effect by performing an adherence construction of a sheet film (e.g., PP, PE, PVC, EVA, and urethane) using adhesive property of an adhesive on the sheet film without heating the a sheet film.

The present disclosure also provides a construction method of a waterproof sheet using a solvent-free adhesive, which has an excellent waterproof effect by simply applying a sheet film (e.g., PP, PE, PVC, EVA, and urethane) to a surface of a structure (e.g., an underground structure, a railway, a bridge, a swimming pool, a landfill, a tunnel, an underground roadway, and a building), and have an excellent adhesive effect on an ethylene vinyl acetate (EVA) foam sheet, a poly ethylene (PE) foam fibrous board, an isopink, a PE rigid board, an asphalt-based rigid board, and a fiber rigid board.

The present disclosure also provides a waterproof sheet and a manufacturing method of the waterproof sheet using a solvent-free adhesive, and a construction method using the waterproof sheet, which can use a reverse placement waterproof construction method of placing a mortar and a concrete on waterproof layer, or placing only the concrete on the waterproof layer.

### Technical Solution

In accordance with an exemplary embodiment, a solvent-free adhesive for a waterproof sheet is manufactured by mixing rubber and tackifier with heated oil in a heat liquefying mixer to form a mixture, and by mixing at least one additive with the mixture.

The additive may include heat stabilizer, antioxidant, reinforcing agent, and filler.

The rubber may be at least one of thermoplastic rubber including Styrene Isoprene Styrene (SIS) and Styrene Butadiene Styrene (SBS), and polymeric synthetic resin dissoluble in the oil, and the oil may be at least one of mineral oil, vegetable oil, and synthetic oil.

In accordance with an exemplary embodiment, a solvent-free adhesive for a waterproof sheet is manufactured by mixing rubber and tackifier with heated oil in a heat liquefying mixer to form a mixture, and by mixing heat stabilizer, antioxidant, reinforcing agent, and filler with the mixture, wherein the oil is at least one of mineral oil, vegetable oil, and synthetic oil.

In accordance with another exemplary embodiment, a waterproof sheet having self-adhesive property includes a basic material sheet not having adhesive property; and a solvent-free adhesive manufactured by mixing rubber and tackifier with heated oil in a heat liquefying mixer, coated on at least one surface of the basic material sheet.

The solvent-free adhesive may further include at least one of heat stabilizer, antioxidant, reinforcing agent, and filler.

The rubber may be at least one of thermoplastic rubber including SIS and SBS, and polymeric synthetic resin dissoluble in the oil, and the oil may be at least one of mineral oil, vegetable oil, and synthetic oil.

The basic material sheet may include at least one of polymeric synthetic resin film sheet, sheet woven with natural and synthetic fiber, mesh sheet woven with natural and synthetic fiber, non-vulcanized rubber sheet, vulcanized rubber sheet, and asphalt sheet, and the waterproof sheet further may include a paper release treated with silicon, or a polymeric synthetic resin film sheet release treated with silicon, attached to one surface of the basic material sheet coated with the adhesive.

In accordance with another exemplary embodiment, a method for manufacturing a waterproof sheet includes: forming a basic material sheet; coating a solvent-free adhesive on at least one surface of the basic material sheet; attaching a released paper to the surface of the basic material sheet coated with the solvent-free adhesive; and cooling the basic material sheet attached with the released paper.

The coating of the solvent-free adhesive may include coating a solvent-free adhesive heated in a heating tank on the basic material sheet, the solvent-free adhesive being maintained to be thick gruel-like, wherein the solvent-free adhesive is manufactured by mixing rubber and tackifier with heated oil in a heat liquefying mixer.

The solvent-free adhesive may include at least one of heat stabilizer, antioxidant, reinforcing agent, and filler, the rubber is at least one of thermoplastic rubber including SIS and SBS, and polymeric synthetic resin dissoluble in the oil, and the oil is at least one of mineral oil, vegetable oil, and synthetic oil.

The coating of the solvent-free adhesive may further include coating the solvent-free adhesive on the basic material sheet when the basic material sheet passes between rollers.

The rollers may be heated to a temperature higher than a normal temperature to prevent hardening of the solvent-free adhesive.

In accordance with another exemplary embodiment, a waterproof construction method includes: coating primer on a surface of a target structure after pre-processing of the surface of the target structure; preparing a waterproof sheet including a released paper attached on one surface of a basic material sheet coated with a solvent-free adhesive manufactured by mixing rubber and tackifier with heated oil in a heat liquefying mixer to form a mixture, and by mixing at least one additive with the mixture; continuously attaching the waterproof sheets to the surface of the target structure to allow end parts of the waterproof sheets to overlap each other after the released paper is removed from the surface of the basic material sheet; and placing mortar, concrete or protective material for waterproof layer on the upper surface of the waterproof sheet.

The waterproof construction method may further include, after the continuous attaching of the waterproof sheets, attaching a waterproof sheet having a predetermined width on an overlap between the waterproof sheets.

In accordance with another exemplary embodiment, a waterproof construction method includes: coating primer on a surface of a target structure after pre-processing of the surface of the target structure; preparing a waterproof sheet including a released paper attached on one surface of a basic material sheet coated with a solvent-free adhesive manufactured by mixing rubber and tackifier with heated oil in a heat liquefying mixer to form a mixture, and by mixing at least one additive with the mixture; continuously attaching the waterproof sheets to the surface of the target structure to allow end parts of the waterproof sheets to be smoothly joined to each other after the release paper is removed from the surface of the basic material sheet; attaching a waterproof sheet having a predetermined width on a joint between the waterproof sheets; and placing mortar, concrete or protective material for waterproof layer on the upper surface of the waterproof sheet.

The continuous attaching of the waterproof sheets may include applying a sealant to an end of the waterproof sheet.

### Advantageous Effects

A solvent-free adhesive can endow strong adhesive property to a polymeric synthetic resin film sheet, and have an advantageous effect of fire prevention and ill-smelling reduction because poisonous solvent (organic solvent such as toluene, or xylene) is excluded.

A waterproof sheet using the solvent-free adhesive has an advantageous effect of preventing volume reduction of an adhesive due to evaporation of solvent.

A solvent-free adhesive for a waterproof sheet, a waterproof sheet and a manufacturing method of the waterproof sheet using the solvent-free adhesive, and a construction method using the waterproof sheet can enhance adhesive property of the waterproof sheet, and facilitate waterproof construction.

A manufacturing method of the waterproof sheet using the solvent-free adhesive can simplify manufacturing equipment to restrain increase of equipment cost, and maximize productivity per hour.

A waterproof sheet and a manufacturing method of the waterproof sheet using the solvent-free adhesive, and a construction method using the waterproof sheet enables a reverse placement waterproof construction by placing mortar and concrete on a waterproof layer, or placing only the concrete on the waterproof layer to allow the waterproof layer to be firmly attached to the concrete.

A solvent-free adhesive for a waterproof sheet, a waterproof sheet and a manufacturing method of the waterproof sheet using the solvent-free adhesive can use a polymeric synthetic film sheet (e.g., PP, PE, PVC, EVA, and urethane) as a waterproof material.

A solvent-free adhesive for a waterproof sheet, a waterproof sheet and a manufacturing method of the waterproof sheet using the solvent-free adhesive are less expensive and convenient to construct, and have an excellent waterproofing effect.

### BRIEF DESCRIPTION OF DRAWINGS

Exemplary embodiments can be understood in more detail from the following description taken in conjunction with the accompanying drawings, in which:

FIG. 1 is a diagram illustrating an exemplary method of manufacturing a solvent-free adhesive;

FIG. 2 is a cross-sectional view of a waterproof sheet according to a first embodiment;

FIG. 3 is a diagram illustrating a process of manufacturing a waterproof sheet according to a first embodiment;

FIG. 4 is a diagram illustrating a first construction method using a waterproof sheet in FIG. 2;

FIG. 5 is a diagram illustrating a second construction method using a waterproof sheet in FIG. 2;

FIG. 6 is a diagram illustrating a process of manufacturing a solvent-free adhesive according to another embodiment;

FIG. 7 is a diagram illustrating a process of manufacturing a waterproof sheet according to a second embodiment;

FIG. 8 is a cross-sectional view of a waterproof sheet according to a second embodiment;

FIG. 9 is a cross-sectional view of a composite waterproof sheet according to a third embodiment;

FIG. 10 is a diagram illustrating an exemplary bored sheet.

FIG. 11 is a diagram illustrating an exemplary joint between waterproof sheets in FIG. 8; and

FIGS. 12 and 13 are diagrams illustrating third and fourth construction methods using a waterproof sheet according to an embodiment.

### BEST MODE FOR CARRYING OUT THE INVENTION

The advantages, features and aspects of the invention will become apparent from the following description of the embodiments with reference to the accompanying drawings, which is set forth hereinafter.

Since a film sheet formed of a polymeric synthetic resin (for example, PP, PE, PVC, EVA, and urethane) has no adhesive property, the film sheets are difficult to be connected so as to have their one ends overlap each other. Accordingly, the film sheets do not be used as a waterproofing material in spite of their excellent properties such as durability and water-resistance.

By endowing adhesive property to the polymeric synthetic resin film sheet to obtain inexpensive, convenient and effective waterproof sheet, the present disclosure provides a solvent-free adhesive for a waterproof sheet, a waterproof sheet and a manufacturing method of the waterproof sheet using the solvent-free adhesive, and a construction method using the waterproof sheet.

The solvent-free adhesive for the waterproof sheet may be manufactured by the following simple method. When a rapeseed oil (main material oil) is boiled at a temperature of from about 150° C. to about 180° C. in a heat liquefying mixer, a thermoplastic elastomer (SBS or SIS), poly-α-olefins resin, and a tackifier are added and mixed in the heating liquefying mixer. After the mixture is fully dissolved, heat stabilizer, antioxidant, reinforcing agent, and filler are added to be uniformly mixed, and then stored at a temperature of from about 100° C. to about 110° C. in a storage tank.

Only one surface of a basic material sheet, which is a polymeric synthetic resin film sheet (for example, PP, PE, PVC, EVA, urethane), is coated with an adhesive. Both surfaces of the basic material sheet may be coated with the adhesive. In this case, however, shoes or hands of a worker may be adhered to the exposed adhesive layer in the subsequent process such as a connection process between the sheets, resulting in obstruction of work.

In an exemplary embodiment, only one surface of the polymeric synthetic resin film sheet is coated with the adhesive. In this case, a construction work becomes more convenient because the other surface of the polymeric synthetic resin film sheet has no adhesive property. Also, amounts of a released paper and an adhesive necessary for manufacturing the waterproof sheet are more reduced than the both surfaces of the polymeric synthetic resin film sheet are coated with the adhesive. Thus, the manufacturing cost and the equipment cost for a coating machine may be reduced.

A method of manufacturing a waterproof sheet by coating only one surface of a basic material sheet that is a polymeric synthetic resin film sheet (for example, PP, PE, PVC, EVA, and urethane) with an adhesive is provided according to an embodiment.

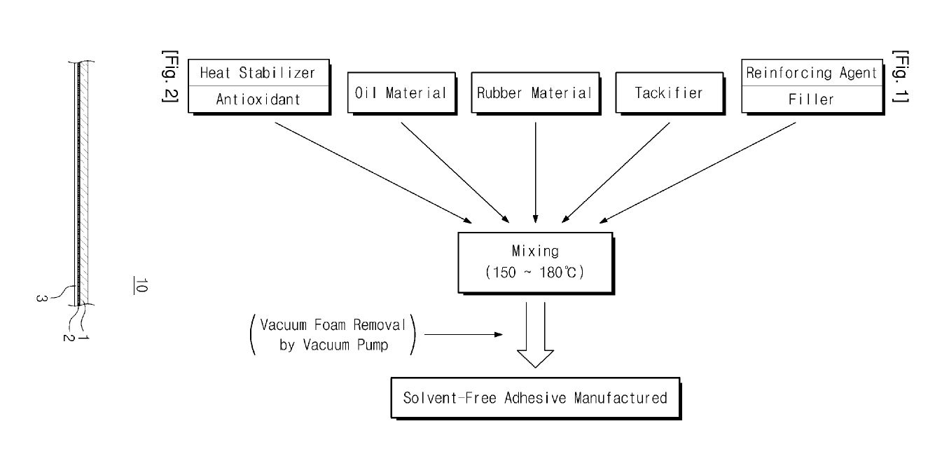

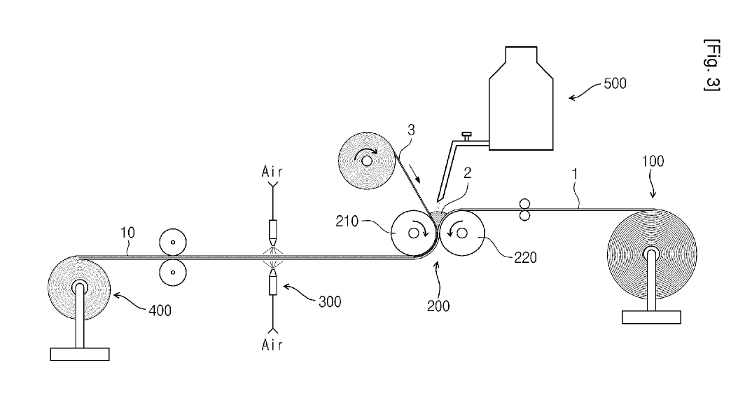

FIG. 1 is a diagram illustrating an exemplary method of manufacturing a solvent-free adhesive. FIG. 2 is a cross-sectional view of a waterproof sheet according to a first embodiment.

Referring to FIG. 1, a solvent-free adhesive for a waterproof sheet is manufactured by the following processes. Thermoplastic elastomer (SBS or SIS) and poly-α-olefins resin are added and mixed when a rapeseed oil (oil material) is boiled at a temperature of from about 150° C. to about 180° C. in a heat liquefying mixer. When the mixture is dissolved, a tackifier (e.g., petroleum resin, rosin, phenol-formaldehyde resin, and polyisobutylene) are added and mixed until fully dissolved. Then, heat stabilizer (e.g., aluminium stearate and barium stearate), antioxidant (e.g., phenyl-α-naphthylamine (PA), substituted diphenylamine (DCD), and trimethyl-dihydroquinoline (RD)), reinforcing agent (e.g., barium sulphate and zinc oxide), and filler (e.g., calcium carbonate and clay) are added to be uniformly mixed. Then, a vacuum foam removal is performed by a vacuum pump. The solvent-free adhesive for the waterproof sheet may be manufactured by adding only a rubber main material (a thermoplastic polymer dissoluble in oil of a high temperature may be used besides a polymeric synthetic resin, and a poly-α-olefins resin) and a tackifier to oil material. Additives (e.g., heat stabilizer, antioxidant, and reinforcing agent, and filler) may be added to manufacture an adhesive having better physical properties.

In an exemplary embodiment, the types and amounts of the additives may be controlled to improve the method for manufacturing the adhesive. The structure of coating machine may be simplified and modified so as to achieve more efficient production.

The adhesive for a waterproof sheet has a high viscosity of solid contents of about 100%. The adhesive has a thick gruel-like shape at a high temperature of more than about 100° C., but is cooled to be a tough rubber-like at a normal temperature, showing high viscosity like wheat-gluten. The adhesive having strong viscosity and adhesion is coated on a surface of a polymeric synthetic resin film sheet (e.g., PP, PE, PVC, EVA, and urethane) by a manufacturing machine as described in FIG. 3.

Referring to FIG. 2, since the adhesive 2 is adhered to a surface of the polymeric synthetic resin film sheet (e.g., PP, PE, PVC, EVA, and urethane) 1 to be incorporated into the polymeric synthetic resin film sheet, an end of one sheet may be simply joined to an end of another sheet, showing excellent attachment to the surface of a base concrete.

Compositions of the adhesive 2 according to an embodiment are as follows:

| | | |
|---|---|---|
| Oil material: Rapeseed oil | 100 | g (%) |
| Elastomer TPE: SBS or SIS | 37 | g (%) |
| Poly-α-olefins resin | 5 | g (%) |
| Tackifier: Petroleum resin | 18 | g (%) |
| Rosin | 13 | g (%) |
| Phenol-formaldehyde resin | 8 | g (%) |
| Polyisobutylene | 6 | g (%) |
| Heat stabilizer: Aluminium stearate | 3 | g (%) |
| Barium stearate | 1 | g (%) |
| Antioxidant: Phenyl-α-naphthylamine (PA) | 1.5 | g (%) |
| Substituted diphenylamine (DCD) | 1.5 | g (%) |
| Trimethyl dihydroquinoline (RD) | 1.3 | g (%) |
| Reinforcing agent: Barium sulphate | 20 | g (%) |
| Zinc oxide | 5 | g (%) |
| Filler: Calcium carbonate | 25 | g (%) |
| Activated clay | 10 | g (%) |

An adhesive according to an embodiment may be manufactured through the following processes. Thermoplastic elastomer (e.g., SBS or SIS) and poly-α-olefins resin are dissolved in a mineral oil (preferably, vegetable oil). A large amount of tackifier (e.g., petroleum resin, rosin, phenol-formaldehyde resin, and polyisobutylene) is added. Reinforcing agent, floccurant (e.g., barium sulphate and zinc oxide) is added to maintain hardness of the adhesive and enhance adhesive strength of the adhesive. Heat stabilizer (e.g., aluminium stearate, and barium stearate), and antioxidant (PA, DCD, and RD) are added. Then, filler (e.g., calcium carbonate and activated clay) is added to manufacture an adhesive for a waterproof sheet showing a high adhesive strength.

The adhesive for a waterproof sheet is manufactured by adding the tackifier and the floccurant to have a high viscosity of solid contents of about 100%. The adhesive has a thick gruel-like shape at a high temperature of more than about 100° C. However, the adhesive is cooled to be elastic like a very tough rubber at a normal temperature as if waterproofing material of a rubber is painted several times.

When a dissolution main material (e.g., mineral oil, vegetable oil, or synthetic oil) is boiled at a temperature of about 150° C. to about 180° C., additives such as a rubber elastomer (e.g., SBS, SIS), and poly-α-olefins resin), and a tackifier are added to make a solvent-free adhesive of 100% solid contents. The adhesive for waterproof sheet may be manufactured through such a simple and eco-friendly method, and be manufactured in large quantities. Since only one surface of the polymeric synthetic resin film sheet (e.g., PP, PE, PVC, EVA, and urethane) is coated with the adhesive, amounts of a released paper and an adhesive necessary for manufacturing the waterproof sheet are more reduced than the both surfaces of the polymeric synthetic resin film sheet are coated with the adhesive. Thus, the manufacturing cost and the equipment cost for a coating machine are reduced.

Besides the thermoplastic rubber elastic resin (e.g., SBS or SIS), a polymeric synthetic resin dissoluble in a boiled oil at a temperature of from about 150° C. to about 180° C., or other thermoplastic polymers may be added to manufacture the waterproof sheet according to an embodiment.

Besides the polymeric synthetic resin film sheet (e.g., PP, PE, PVC, EVA, and urethane), filament nonwoven, natural and synthetic fiber, non-vulcanized rubber sheet, vulcanized rubber, and asphalt may be used as a basic material sheet. Accordingly, the adhesive according to an embodiment may be coated on a surface of the basic material sheet.

When asphalt is used as a basic material sheet, a polymeric synthetic resin film sheet (e.g., PP, PE) having a very thin thickness of from about 0.02 mm to about 0.04 mm may be attached to the upper surface and the lower surface of the asphalt. After the asphalt is blocked by the polymeric synthetic resin film sheet, the adhesive may be coated on the polymeric synthetic resin film sheet. Unlike a related art asphalt sheet waterproofing material, the adhesive according to an embodiment enables connection between sheets without heating of a heating device (e.g., a torch, and a burner).

The adhesive for waterproof sheet enables massive production by a simple and eco-friendly method. In a single manufacturing process, the adhesive may be coated on one surface of the polymeric synthetic resin film sheet (basic material sheet), providing a very simple and eco-friendly manufacturing method.

FIG. 3 is a diagram illustrating a process of manufacturing a waterproof sheet according to a first embodiment.

Referring to FIG. 3, an apparatus for manufacturing a waterproof sheet 10 may include an unwinding unit 100, a processing unit 200, a cooling unit 300, and a winding unit 400. A polymeric synthetic resin film sheet (hereinafter, a basic material sheet) 1 is wound on the unwinding unit 100. In the processing unit 200, an adhesive 2 is coated on a surface of the basic material sheet 1, and a released paper 3 is attached thereon. The cooling unit 300 injects air to cool the adhesive to a normal temperature. The waterproof sheet 10 is wound on the winding unit 400.

The basic material, polymeric synthetic resin film sheet used for the waterproof sheet 100 is wound on a feeding reel of the unwinding unit 100. The basic material sheet 1 unwound from the unwinding unit 100 is manufactured into the waterproof sheet 10 while passing through the processing unit 200 and the cooling unit 300 by guide rollers. The waterproof sheet 10 including the released paper 3 is cut off whenever the waterproof sheet 10 of from about 10 m to about 20 m is wound on a winding reel of the winding unit 400.

As an example, the basic material sheet 1 having a predetermined width and thickness is provided from the unwinding unit 100 to the processing unit 200. When the basic material sheet 1 provided to the processing unit 200 is passed through first and second rollers 210 and 220, the adhesive 2 is coated on a surface of the basic material sheet 1, and simultaneously, the released paper 3 is attached to the coated surface of the basic material sheet 1. The first and second rollers 210 and 220 may be a heating roller to prevent the adhesive from cooling. The heating roller may be heated to a temperature of from about 70° C. to about 90° C. higher than a normal temperature. The temperature of the first roller 210 contacting the released paper 3 may be from about 70° C. to about 80° C., and the temperature of the second roller 220 contacting the basic material sheet 1 may be from about 80° C. to about 90° C. After the basic material sheet 1 having passed the processing unit 200 is cooled to a normal temperature by air injected from the cooling unit 300, the basic material sheet 1 is finally wound on the winding unit 400 to be packaged in a predetermined length.

The method for manufacturing a solvent-free adhesive will be described again. Thermoplastic elastomer (SBS or SIS) (e.g., 37 g) and poly-α-olefins resin (5 g) are added and mixed when a rapeseed oil (e.g., 100 g) is boiled at a temperature of from about 150° C. to about 180° C. in a heat liquefying mixer. When the mixture is dissolved, a tackifier (e.g., petroleum resin (18 g), rosin (13 g), phenol-formaldehyde resin (8 g), and polyisobutylene (6 g)) are added and mixed in the heat liquefying mixer until fully dissolved. When thermoplastic elastomer and the tackifier are fully dissolved, heat stabilizer (e.g., aluminium stearate (3 g) and barium stearate (1 g)), antioxidant (e.g., PA (1.5 g), DCD (1.5 g), and RD (1.3 g)), reinforcing agent (e.g., barium sulphate (20 g), and zinc oxide (5 g)), and filler (e.g., calcium carbonate (25 g) and clay (10 g)) are added to be uniformly mixed.

Then, the adhesive is moved to a heating tank 600, where the adhesive is heated to a temperature of from about 100° C. to about 110° C. to maintain a thick gruel-like state, and coated on the basic material sheet.

More specifically, the waterproof sheet is manufactured by coating the adhesive on a basic material sheet having a thickness of from about 0.3 mm to about 2 mm and a width of about 100 cm, in a thickness of from about 0.3 mm to about 1 mm.

That is, because the thick basic material sheet as well as the adhesive has a function of a waterproof material, the waterproof sheet performs a dual waterproofing function. Accordingly, the waterproof sheet has more excellent waterproofing and adhesive properties than a related art sheet waterproofing material that requires a separate adhesive or an instrument to connect between sheets. Even when construction area is broad, the waterproof sheet shows an effect as if only one sheet is placed.

Since the polymeric synthetic resin waterproof sheet according to an embodiment is coated with a thick and strong adhesive of from about 0.3 mm to about 1 mm, the adhesive is fully attached to the whole area of a base concrete. Even if a waterproof defect occurs because of carelessness, water does not flow under the waterproof layer, thereby facilitating detection and repair of the defect.

A construction method of a waterproof sheet according to an embodiment reduces a construction cost by a very convenient and quick construction, and shows a perfect waterproof effect, by attaching the polymeric synthetic film sheet (e.g., PE, PP, PVC, EVA, and urethane) using an adhesive property of an adhesive coated thereon, not by using a hot wind or a heat fusion like a related art construction method of a waterproof material.

The construction method of a waterproof sheet using a solvent-free adhesive shows an excellent waterproof effect by simply attaching a polymeric synthetic resin sheet film (e.g., PP, PE, PVC, EVA, and urethane) to a surface of a structure (e.g., an underground structure, a railway, a bridge, a swimming pool, a landfill, a tunnel, an underground roadway, and a building), and have an excellent adhesive effect on an ethylene vinyl acetate (EVA) foam sheet, a poly ethylene (PE) foam fibrous board, an isopink, a PE rigid board, an asphalt-based rigid board, and a fiber rigid board, which are used as protective materials of a waterproof layer during refilling.

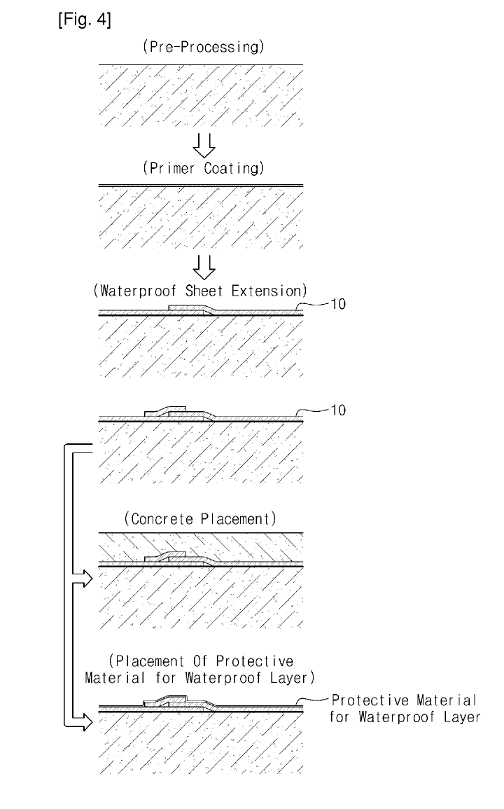

FIG. 4 is a diagram illustrating a first construction method using a waterproof sheet in FIG. 2.

Referring to FIG. 4, after a certain surface (base concrete) of a target structure is preprocessed, a primer is thinly coated. The pre-processing is performed to remove laitance, unevenness, crack, humidity, water, and oil on the surface of the target structure to be waterproofed. After released papers 3 are removed from waterproof sheets 100, the waterproof sheets 100 are disposed on the surface of the target structure so that the one ends thereof overlap each other by about 10 cm. Then, a waterproof sheet having a width of from about 10 cm to about 15 cm is attached on the overlapping end. A protective material (e.g., PP, PE, or EVA foam sheet, an isopink, a PE rigid board, an asphalt-based rigid board, and natural or synthetic fiber rigid board) of the waterproof layer is further disposed on the waterproof sheets, or a concrete is casted. When the target structure is a floor, the concrete may be casted. When the target structure is a wall or a ceiling, the protective material may be attached.

Since the adhesive layer of the waterproof sheet is strongly and airtightly attached to the whole area of the target structure, movement of leaked water under the waterproof layer is prevented. The overlapping part having a width of about 10 cm shows a double waterproof effect due to the properties and features of the polymeric synthetic resin film sheet and the adhesive layer that are incorporated into one. Furthermore, the reinforcing attachment of the waterproof sheet having a width of from about 10 cm to about 15 cm enables dual or triple waterproof effect.

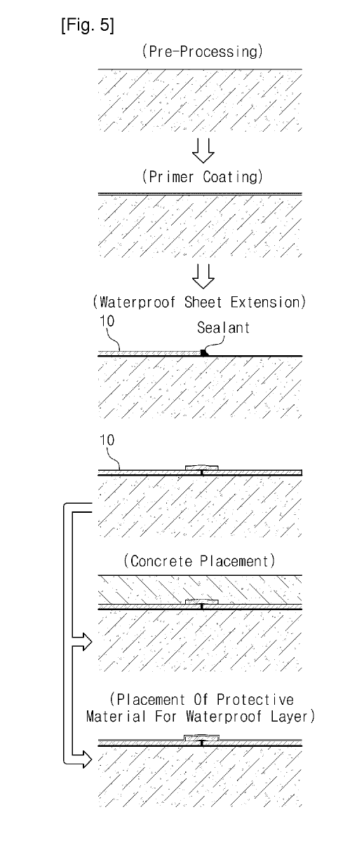

FIG. 5 is a diagram illustrating a second construction method using a waterproof sheet in FIG. 2.

Referring to FIG. 5, after a certain surface (base concrete) of a target structure is preprocessed, a primer is coated. When a waterproof sheet is disposed on the surface of the target structure, a sealant is applied to the end of the waterproof sheet. The waterproof sheet is extended by disposing another waterproof sheet so that the ends of the waterproof sheets are smoothly connected to each other. Then, a waterproof sheet having a width of from about 10 cm to about 15 cm is attached on a joint between the waterproof sheets. A protective material (e.g., PP, PE, or EVA foam sheet, an isopink, a PE rigid board, an asphalt-based rigid board, and natural or synthetic fiber rigid board) of the waterproof layer, having a certain thickness, is further disposed on the waterproof sheets, or a concrete is casted.

Even after laitance, unevenness, crack, humidity, water, and oil are removed from the surface of the target structure to be waterproofed through the pre-processing, cement powder and dust may remain to decrease the adhesive strength. Accordingly, the primer is thinly coated to tightly attach the polymeric synthetic resin waterproof sheet. The primer is manufactured by diluting a strong adhesive with an organic solvent, and is coated with a brush or a spray. The sealant is manufactured to be thick gruel-like by dissolving the adhesive in a small amount of organic solvent. The thick gruel-like sealant is coated with a large flat spoon or a scraper.

To explain the construction effect according to an embodiment, the whole area of an adhesive layer of a polymeric synthetic resin waterproof sheet is strongly attached to the surface of the target structure. After a sealant is applied to the end of the waterproof sheet, the waterproof sheet is extended by disposing another waterproof sheet so that the ends of the waterproof sheets are smoothly connected to each other. Then, a waterproof sheet having a width of from about 10 cm to about 15 cm is attached on a joint between the waterproof sheets. When the later waterproof sheet is disposed, the sealant applied to the end of the previous waterproof sheet is pushed to be also applied to the end of the later waterproof sheet. After the both ends of the waterproof sheets are sealed, the excessive sealant is pushed up to cover a joint between the waterproof sheets. Accordingly, the joint between the waterproof sheets is filled and covered with the sealant. In addition, the waterproof sheet having a width of from about 10 cm to about 15 cm is attached on the joint between the waterproof sheets, leading to dual or triple waterproof effect.

When the waterproof sheet is applied to a vulnerable part such as an H-beam, an internal pipe, a joint between sheets, an edge, and a lower corner of a lift-up, a waterproof sheet manufactured by coating an adhesive on a PP, or PE film sheet having a thickness of from about 0.2 mm to about 0.4 mm, or a sheet woven with PP or PE fiber may be used. Because the waterproof sheet using a basic material sheet having a thickness of from about 0.2 mm to about 0.4 mm has excellent flexibility and tensile strength, waterproof construction at the vulnerable part is very convenient and effective.

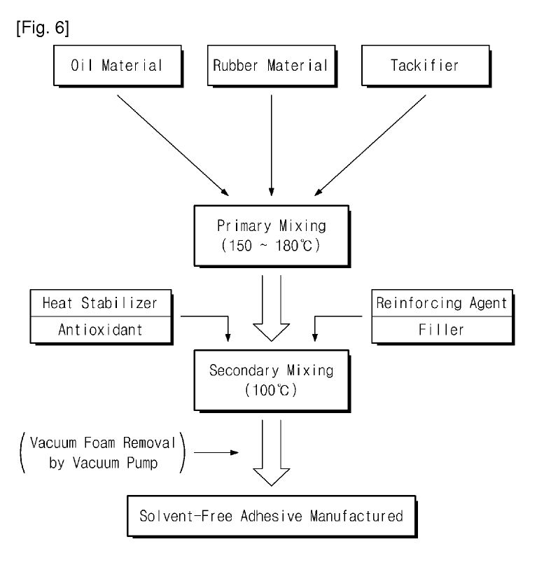

FIG. 6 is a diagram illustrating a process of manufacturing a solvent-free adhesive according to another embodiment.

Referring to FIG. 6, a solvent-free adhesive is manufactured by the following processes. Thermoplastic elastomer (SBS or SIS) is added and mixed when a rapeseed oil (oil material) is boiled at a temperature of from about 150° C. to about 180° C. When the mixture is dissolved, a tackifier (e.g., petroleum resin, rosin, and phenol-formaldehyde resin) are added and mixed until fully dissolved. After the heating of the mixing tank is stopped, heat stabilizer (e.g., aluminium stearate and barium stearate), antioxidant (e.g., phenyl-α-naphthylamine (PA), substituted diphenylamine (DCD), and trimethyl-dihydroquinoline (RD)), reinforcing agent (e.g., white carbon and zinc oxide), and filler (e.g., calcium carbonate and clay) are added to be uniformly mixed. Then, Vacuum foam removal is performed by a vacuum pump.

The adhesive has a high viscosity of solid contents of about 100%. The adhesive has a thick gruel-like shape at a high temperature of more than about 100° C., but is cooled to be a tough rubber-like at a normal temperature, showing a high viscosity like a wheat-gluten. The solvent-free adhesive having such a viscosity and an adhesion is coated on an upper surface and a lower surface of a polymeric synthetic resin film sheet (e.g., PP, PE, PVC, EVA, and urethane) by a manufacturing machine as described in FIG. 7.

Since the adhesive is adhered to both upper and lower surfaces of the polymeric synthetic resin film sheet (e.g., PP, PE, PVC, EVA, and urethane) to be incorporated into the polymeric synthetic resin film sheet, an end of one sheet may be simply joined to an end of another sheet, showing very excellent attachment to the surfaces of a base concrete and a protective material (e.g., cement mortar, and PP and PE foam sheet) of a waterproof layer. Accordingly, even a broad construction area may be waterproofed with one waterproof sheet of a polymeric synthetic resin film sheet.

Compositions of the adhesive according to another embodiment are as follows.

| | | |
|---|---|---|
| Oil material: Rapeseed oil | 100 | g (%) |
| Elastomer TPE: SBS or SIS | 40 | g (%) |
| Tackifier: petroleum resin | 18 | g (%) |
| Rosin | 13 | g (%) |
| Phenol-formaldehyde resin | 8 | g (%) |
| Heat stabilizer: Aluminium stearate | 3 | g (%) |
| Barium stearate | 1 | g (%) |
| Antioxidant: Phenyl-α-naphthylamine (PA) | 1.5 | g (%) |
| Substituted diphenylamine (DCD) | 1.5 | g (%) |
| Trimethyl dihydroquinoline (RD) | 1.3 | g (%) |
| Reinforcing agent: White carbon | 15 | g (%) |
| Zinc oxide | 5 | g (%) |
| Filler: Caolin | 30 | g (%) |
| Activated clay | 10 | g (%) |

An adhesive according to an embodiment may be manufactured through the following processes. Thermoplastic elastomer (TPE) (e.g., SBS or SIS) is dissolved in a mineral oil, or a vegetable oil. A large amount of tackifier (e.g., petroleum resin, rosin, and phenol-formaldehyde resin) is added. Reinforcing agent (e.g., white carbon and zinc oxide) is added to maintain hardness of the adhesive and enhance adhesive strength of the adhesive. Then, filler (e.g., caolin and activated clay) is added to manufacture an adhesive for a waterproof sheet showing a high adhesive strength.

The thermoplastic elastomer (TPE) may include SBS or SIS. SBS having excellent expansion coefficient and SIS having excellent tensile strength may be mixed to exert both excellent properties according to a user request.

The oil may include a petroleum-based mineral oil. However, the oil may include a vegetable oil including a drying oil (e.g., a linseed oil) and a semi-drying oil (e.g., a rapeseed oil), which showed very tough elastic rubber property and strong adhesive property in an experiment performed by the present inventor.

There is a method for manufacturing a polymeric synthetic resin sheet waterproof material using a method for manufacturing a solvent-free adhesive. The method includes the following processes. The solvent-free adhesive is manufactured by adding oil and tackifier to rubber and mixing them in a kneader or an open roller for rubber. The adhesive is rolled in calendar, or extruded from a T-die to be coated on the surface of a polymeric synthetic resin film sheet (e.g., PP, PE, EVA, and urethane). However, this manufacturing method is very complicated and less productive due to the adhesive property and very high fluidity of the adhesive. Also, it is difficult to coat the adhesive on both upper and lower surfaces of the polymeric synthetic resin film sheet.

There is another method for manufacturing a liquefied adhesive by dissolving rubber in an organic solvent in a liquefying mixer. However, the liquefied adhesive has a solid content of from about 40% to about 60%, and is smelly and inflammable due to an organic solvent. When the liquefied adhesive is coated on the polymeric synthetic resin film sheet in a constant thickness, the organic solvent needs to be evaporated into the atmosphere. Only solid content is coated on the polymeric synthetic resin film sheet. During evaporation, there is a danger of smelling and fire. Furthermore, the adhesive is coated on only one surface of the polymeric synthetic resin film sheet. Thus, it is actually difficult to manufacture the adhesive using the above method. Also, there is a limitation in manufacturing the polymeric synthetic resin film sheet. In order to attach an adhesive to the polymeric synthetic resin film sheet (e.g., PP, PE, EVA, PVC, and urethane), the method for manufacturing the solvent-free adhesive according to the embodiments was developed by laborious trial and error.

In order to manufacture an excellent adhesive, various kinds of tackifiers and additives need to be added to rubber. However, high adhesive property of an adhesive becomes an obstacle to the manufacture of the adhesive in a roller or a calendar. When rubber is liquefied in an organic solvent, low solid content causes a necessary evaporation of the organic solvent for an adequate viscous rubber. Smelling and fire risk during evaporation of the organic solvent, and manufacturing inefficiency make this method difficult to select.

The adhesive according to the present invention is a solvent-free adhesive of solid content of about 100% manufactured by dissolving elastic rubber in oil and adding an additive such as a tackifier thereto. The adhesive enables massive production by a simple and eco-friendly method. In a single manufacturing process, the adhesive may be coated on both upper and lower surfaces of the polymeric synthetic resin film sheet, providing a very simple and eco-friendly manufacturing method.

The polymeric synthetic resin film sheet waterproof material (waterproof sheet) manufactured by the above method has strong adhesive strength. Accordingly, construction of the polymeric synthetic resin film sheet is very simple and convenient. The waterproof effect is very significant compared to a related art waterproof material.

A related art polymeric synthetic resin film sheet (e.g., PP, PE, EVA, PVC, and urethane) has no adhesive property, leading to difficulty of joint connection between sheets. According to the embodiment of the present invention, the adhesive is enclosingly coated on both upper and lower surfaces of the polymeric synthetic resin film sheet in a sandwich structure. Accordingly, the polymeric synthetic resin film sheet waterproof material has excellent tensile strength, tearing strength, high expansion coefficient, durability, and waterproofing that a film sheet formed of a polymeric synthetic resin (PP, PE, EVA, PVC, and urethane) has. The joint between sheets is performed by self-adhesive performance. Accordingly, the polymeric synthetic resin film sheet waterproof material is inexpensive, and effective as a waterproof sheet.

In order to attach an adhesive to the polymeric synthetic resin film sheet, two types of pre-processing may be performed according to the thickness of the polymeric synthetic resin sheet. If the thickness of the synthetic resin is from about 0.1 mm to about 1 mm, the film sheet is pre-processed by a corona discharge treatment. In this case, the adhesive is strongly attached to the polymeric synthetic resin film sheet. If the thickness of the synthetic resin is from about 1 mm to about 2 mm, the adhesive is filled in a plurality of penetration holes having a diameter of from about 2 mm to about 5 mm, penetrating the whole surface of the polymeric synthetic resin film sheet. In this case, the rubbery adhesive is firmly attached in a constant on the upper and lower part of the polymeric synthetic resin film sheet.

Referring again to FIG. 6, the method for manufacturing a solvent-free adhesive will be described again. Thermoplastic elastomer (SBS or SIS) (e.g., 40 g) and poly-α-olefins resin (5 g) are added and mixed when a rapeseed oil (e.g., 100 g) is boiled at a temperature of from about 150° C. to about 180° C. in a heat liquefying mixer capable of maintaining a predetermined temperature. When the mixture is dissolved, a tackifier (e.g., petroleum resin (18 g), rosin (13 g), and phenol-formaldehyde resin (8 g)) are added and mixed in the heat liquefying mixer until fully dissolved. When thermoplastic elastomer and the tackifier are fully dissolved, heat stabilizer (e.g., aluminium stearate (3 g) and barium stearate (1 g)), antioxidant (e.g., PA (1.5 g), DCD (1.5 g), and RD (1.3 g)), and reinforcing agent (e.g., white carbon (15 g), and zinc oxide (5 g)) are added and stirred. Finally, filler (e.g., caolin (30 g) and clay (10 g)) are added and stirred to manufacture the adhesive. Then, the adhesive is moved to a heating tank, where the adhesive is heated to a temperature of about 100° C. to maintain a thick gruel-like state. The adhesive may be stored at a normal temperature for future use.

FIG. 7 is a diagram illustrating a process of manufacturing a waterproof sheet according to a second embodiment.

Referring to FIG. 7, an apparatus for manufacturing the waterproof sheet includes an unwinding unit 100, a coating unit 600, a cooling unit 300, a released paper attachment unit 700, and a winding unit 400.

A polymeric synthetic resin film sheet 1 (basic material sheet) is wound on the unwinding unit 100. The adhesive coating unit 600 coats an adhesive 2 on the upper and lower surfaces of the polymeric synthetic resin film sheet 1. The cooling unit 300 injects air to cool the adhesive 2 coated on the polymeric synthetic resin film sheet 1 to a normal temperature. The released paper attachment unit 700 attaches a released paper 3 to the polymeric synthetic resin film sheet 1. The resulting waterproof sheet 10 is wound on the winding unit 400.

Although the polymeric synthetic resin film sheet is exemplified as a basic material sheet, the basic material sheet 1 may include one of nonwoven, sheet woven with natural and synthetic fiber, mesh sheet woven with natural and synthetic fiber, non-vulcanized rubber sheet, and vulcanized rubber sheet.

The basic material, polymeric synthetic resin film sheet used for the waterproof sheet 100 is wound on a feeding reel of the unwinding unit 100. The basic material sheet 1 unwound from the unwinding unit 100 is manufactured into the waterproof sheet 10 while passing through the adhesive coating unit 600, the cooling unit 300, and the released paper attachment unit 700 by guide rollers. The waterproof sheet 10 including the released paper is cut off whenever the waterproof sheet 10 of from about 10 m to about 20 m is wound on a winding reel of the winding unit 400.

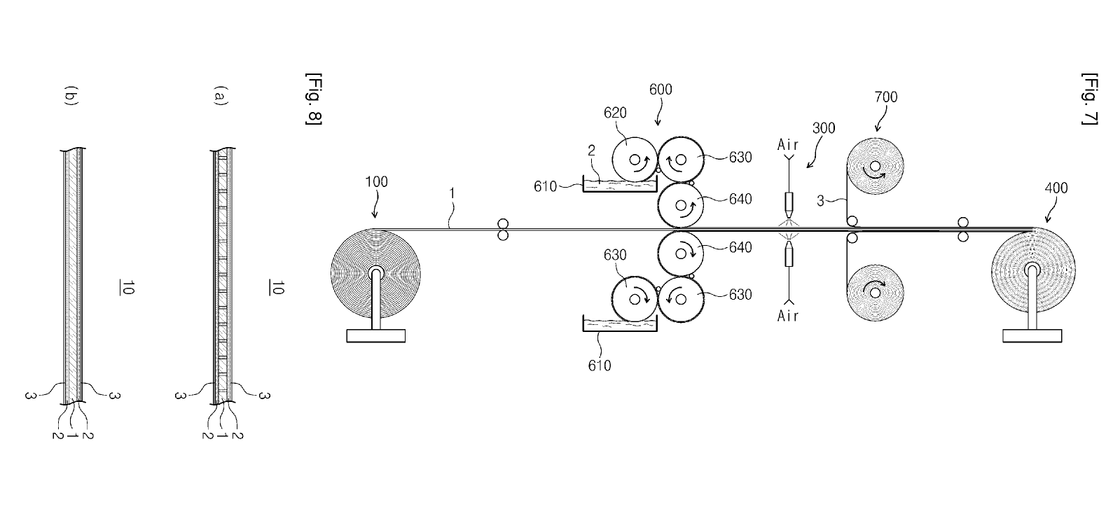

As an example, the polymeric synthetic resin film sheet (e.g., PP, PE, PVC, EVA, and urethane) 1 having a predetermined width of about 100 cm and a predetermined thickness of from 0.1 mm to 2 mm is provided from the unwinding unit 100 to the adhesive coating unit 600. In this case, the polymeric synthetic resin film sheet 1 may be a film sheet processed by a corona discharge treatment or a boring process for forming a plurality of penetration holes. Then, the adhesive 2 is uniformly coated on the upper and lower surfaces of the polymeric synthetic resin film sheet 1 while the polymeric synthetic resin film sheet 1 passes between third rollers 640. A first roller 620 is partly immersed in a tank 610 containing the adhesive 2. The first roller 620 is rotated to firstly regulate a thickness of the adhesive layer in conjunction with the second roller 630. The thickness of the adhesive layer is finally regulated between the second roller 630 and the third roller 640. In this case, the first, second and third rollers 620, 630 and 640 may be a heating roller heated to a temperature higher than a normal temperature to prevent the hardening of the adhesive. When the polymeric synthetic film sheet 1 passes between the third rollers 640, the adhesive 2 is coated on the upper and lower surfaces of the polymeric synthetic film sheet 1 in a predetermined thickness. After the polymeric synthetic resin film sheet 1 having passed the adhesive coating unit 600 is cooled to a normal temperature at the cooling unit 300, a released paper 3 is attached to the upper and lower surfaces of the polymeric synthetic resin film sheet 1. The released paper 3 may be a HDPE film sheet or a paper treated with a release agent. The resulting waterproofing sheet 10 is finally wound on the winding unit 400 to be packaged by a predetermined length of about 10 m to about 20 m. A waterproof sheet 10 as illustrated in FIG. 8A includes an adhesive layer 2 formed on the upper and lower surfaces of the polymeric synthetic resin film sheet 1 having a plurality of penetration holes, and a released paper 3 attached on the adhesive layer 2. A waterproof sheet 10 as illustrated in FIG. 8B includes an adhesive layer 2 formed on the upper and lower surfaces of the polymeric synthetic resin film sheet 1 without penetration holes, and a released paper 3 attached on the adhesive layer 2.

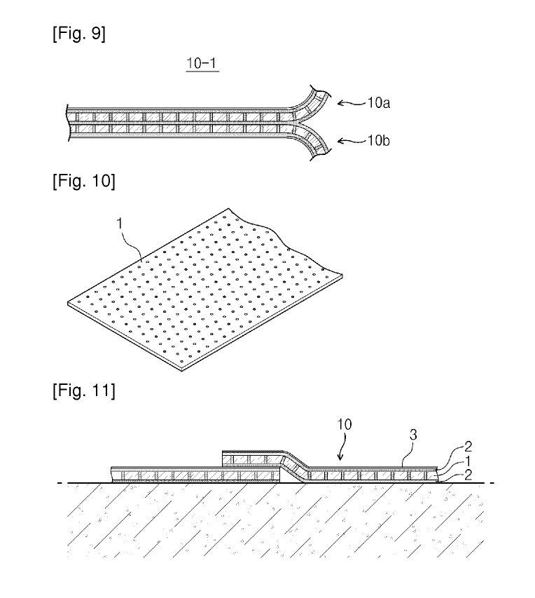

FIG. 9 is a cross-sectional view of a composite waterproof sheet according to a third embodiment.

Referring to FIG. 9, a method for manufacturing a waterproof sheet according to an embodiment will be described. When a first sheet 10a is manufactured by attaching the adhesive, as described above, to the upper and lower surfaces of a polymeric synthetic resin film sheet, a second sheet 10b is manufactured by attaching the adhesive to the polymeric synthetic resin film sheet having the same or a different thickness, or a sheet such as a synthetic fiber sheet or a mesh synthetic fiber sheet. The first and second sheets 10a and 10b are attached to each other to manufacture a composite waterproof sheet. Thus, various types of waterproof sheets may be manufactured.

Methods for manufacturing a waterproof sheet according to other embodiments will be described. If the solvent-free adhesive as described above may be coated on a sheet woven with natural and synthetic fiber or a mesh sheet woven with natural and synthetic fiber, as well as a polymeric synthetic resin film sheet, a self-adhesive waterproof sheet may be manufactured based on a fiber sheet. If the solvent-free adhesive is coated on non-vulcanized rubber sheet and vulcanized rubber sheet, a self-adhesive waterproof sheet may be manufactured based on a rubber sheet.

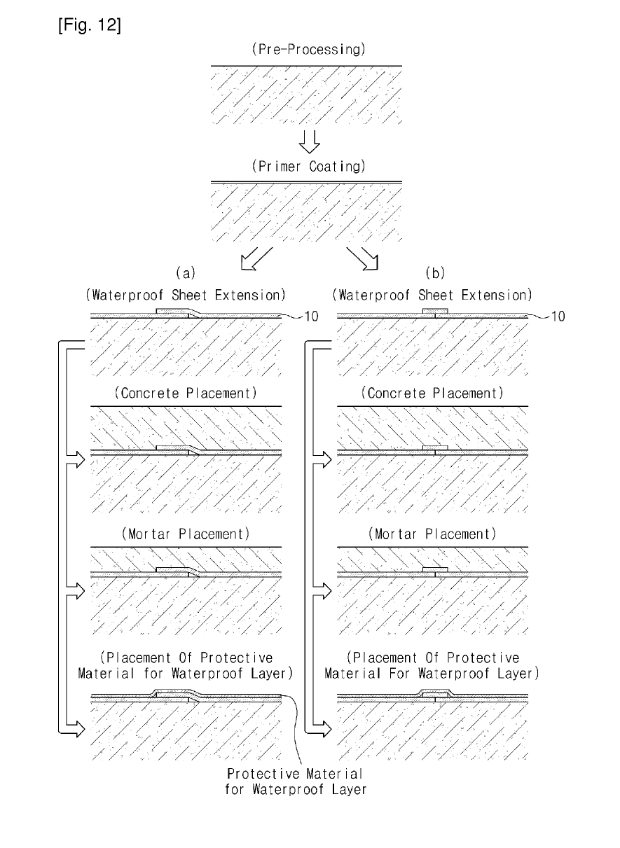

FIGS. 11 to 13 are diagrams illustrating various construction methods using a waterproof sheet according to an embodiment.

A construction method using the waterproof sheet as described above may include pre-processing a base concrete to remove laitance, unevenness, crack, humidity, water, and oil on the surface of the target structure to be waterproofed; thinly coating a primer on the surface of the target structure with a spray, a brush, or a painting roller; preparing a plurality of waterproof sheets manufactured by attaching an adhesive to a polymeric synthetic resin film sheet having a width of about 100 cm and a thickness of from about 0.1 mm to about 2 mm; attaching the waterproof sheet to the base concrete while a released paper treated with silicon is removed from the lower surface of the polymeric synthetic resin film sheet, the waterproof sheet being extended while overlapping each other by about 10 cm (a in FIG. 12); and placing concrete, mortar, or protective material for waterproof layer on the waterproof sheet after a released paper is removed from the upper surface of the polymeric synthetic resin film sheet attached on the base concrete.

Besides overlapping the ends of the waterproof sheet, the waterproof sheet may be extended by attaching a waterproof sheet having a predetermined width of about 10 cm on a joint between the waterproof sheets (b in FIG. 12).

Another construction method for waterproofing of a vertical wall of an underground structure using the waterproof sheet as described above may include pre-processing a base concrete to remove laitance, unevenness, crack, humidity, water, and oil on the surface of the target structure to be waterproofed; attaching the waterproof sheet from a lower part of the wall to an upper part of the wall while a released paper treated with silicon is removed from the lower surface of the polymeric synthetic resin film sheet, the waterproof sheet being extended while overlapping each other by about 10 cm; and attaching mortar of about 10 mm to about 20 mm to protect a waterproof layer after a released paper is removed from the upper surface of the polymeric synthetic resin film sheet attached on the concrete wall, or one of PP, PE, or EVA foam sheet, an isopink, a PE rigid board, an asphalt-based rigid board, and natural or synthetic fiber rigid board, having a thickness of from about 10 mm to about 20 mm.

Another construction method for waterproofing of a deck of a bridge using the waterproof sheet as described above may include pre-processing the bottom of the bridge to clean a steel structure of the bridge; attaching a waterproof sheet after a released paper is removed from the lower surface of the waterproof sheet, the waterproof sheet being extended while overlapping each other by about 10 cm; and placing SBR latex modified concrete having a predetermined thickness of from about 50 mm to about 100 mm on the waterproof sheet after a released paper is removed from the upper surface of the waterproof sheet.

The adhesive waterproof sheet as described above is very firmly attached to mortar or steel plate. When the steel plate is rusty, the waterproof sheet may be attached after a primer is thinly coated on the surface of the steel plate.

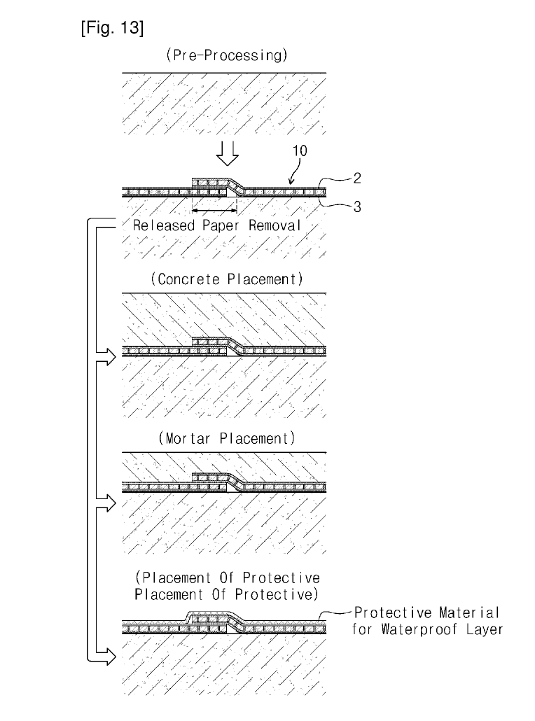

Referring to FIG. 13, another construction method for reverse placement of the bottom of underground structure, the ceiling of underground parking lot, or the wall of structure may include pre-processing a base concrete to remove laitance, unevenness, crack, humidity, water, and oil on the surface of the target structure to be waterproofed; attaching an adhesive to a polymeric synthetic resin film sheet having a width of about 100 cm and a thickness of from about 0.1 mm to 2 mm; placing a waterproof sheet 10 having released papers 2 and 3 attached on the upper and lower surfaces thereof on the target structure, the released paper 3 being not removed from the lower surface of the waterproof sheet 10; taking off a part of the released paper 3 from only the lower surfaces of both ends of the waterproof sheets 10, the waterproof sheets 10 overlapping each other by about 10 cm; placing mortar, concrete, or protective material on the waterproof sheet 10 after a released paper 2 is removed from the upper surface of the waterproof sheet 10 attached to the target structure.

The reverse placement waterproof construction method is discriminated from a typical waterproof construction method. When a waterproof sheet is strongly attached to a target structure, repeated contraction and relaxation of base concrete of the target structure may result in a sudden crack on the surface of the target structure. The width of the crack may be greater than 1 mm, and may even range from about 20 mm to about 30 mm. In this case, the waterproof sheet attached to the base concrete may be cracked together, leading to a water leakage. In order to solve this limitation, the lower surface of the waterproof sheet is spaced from the target structure without being firmly attached thereto, while the upper surface of the waterproof sheet is attached to mortar, concrete, or protective material. That is, only one surface of the waterproof sheet is attached to concrete.

The present application contains subject matter related to Korean Patent Applications No. 2008-43507 and No. 2009-23829, filed in the Korean Intellectual Property Office on May 9, 2008, and Mar. 20, 2009, respectively, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

1. A solvent-free adhesive for a waterproof sheet, manufactured by mixing rubber and tackifier with heated oil in a heat liquefying mixer to form a mixture, and by mixing at least one additive with the mixture.

2. The solvent-free adhesive of claim 1, wherein the additive comprises heat stabilizer, antioxidant, reinforcing agent, and filler.

3. The solvent-free adhesive of claim 1, wherein the rubber is at least one of thermoplastic rubber comprising Styrene Isoprene Styrene (SIS) and Styrene Butadiene Styrene (SBS) and polymeric synthetic resin dissoluble in the oil, and the oil is at least one of mineral oil, vegetable oil, and synthetic oil.

4. A solvent-free adhesive for a waterproof sheet, manufactured by mixing rubber and tackifier with heated oil in a heat liquefying mixer to form a mixture, and by mixing heat stabilizer, antioxidant, reinforcing agent, and filler with the mixture, wherein the oil is at least one of mineral oil, vegetable oil, and synthetic oil.

5. A waterproof sheet having self-adhesive property, comprising:
a basic material sheet not having adhesive property; and
a solvent-free adhesive manufactured by mixing rubber and tackifier with heated oil in a heat liquefying mixer, coated on at least one surface of the basic material sheet.

6. The waterproof sheet of claim 5, wherein the solvent-free adhesive further comprises at least one of heat stabilizer, antioxidant, reinforcing agent, and filler.

7. The waterproof sheet of claim 5, wherein the rubber is at least one of thermoplastic rubber comprising SIS and SBS, and polymeric synthetic resin dissoluble in the oil, and the oil is at least one of mineral oil, vegetable oil, and synthetic oil.

8. The waterproof sheet of claim 7, wherein the basic material sheet comprises at least one of polymeric synthetic resin film sheet, sheet woven with natural and synthetic fiber, mesh sheet woven with natural and synthetic fiber, non-vulcanized rubber sheet, vulcanized rubber sheet, and asphalt sheet, and the waterproof sheet further comprises a paper release treated with silicon, or a polymeric synthetic resin film sheet release treated with silicon, attached to one surface of the basic material sheet coated with the adhesive.

9. A method for manufacturing a waterproof sheet, comprising:
forming a basic material sheet;
coating a solvent-free adhesive on at least one surface of the basic material sheet;
attaching a released paper to the surface of the basic material sheet coated with the solvent-free adhesive; and
cooling the basic material sheet attached with the released paper.

10. The method of claim 9, wherein the coating of the solvent-free adhesive comprises coating a solvent-free adhesive heated in a heating tank on the basic material sheet, the solvent-free adhesive being maintained to be thick gruel-like, wherein the solvent-free adhesive is manufactured by mixing rubber and tackifier with heated oil in a heat liquefying mixer.

11. The method of claim 10, wherein the solvent-free adhesive comprises at least one of heat stabilizer, antioxidant, reinforcing agent, and filler,
the rubber is at least one of thermoplastic rubber comprising SIS and SBS, and polymeric synthetic resin dissoluble in the oil, and
the oil is at least one of mineral oil, vegetable oil, and synthetic oil.

12. The method of claim 10, wherein the coating of the solvent-free adhesive further comprises coating the solvent-free adhesive on the basic material sheet when the basic material sheet passes between rollers.

13. The method of claim 12, wherein the rollers are heated to a temperature higher than a normal temperature to prevent hardening of the solvent-free adhesive.

14. A waterproof construction method comprising:
coating primer on a surface of a target structure after pre-processing of the surface of the target structure;
preparing a waterproof sheet comprising a released paper attached on one surface of a basic material sheet coated with a solvent-free adhesive manufactured by mixing rubber and tackifier with heated oil in a heat liquefying mixer to form a mixture, and by mixing at least one additive with the mixture;
continuously attaching the waterproof sheets to the surface of the target structure to allow end parts of the waterproof sheets to overlap each other after the released paper is removed from the surface of the basic material sheet; and
placing mortar, concrete or protective material for waterproof layer on the upper surface of the waterproof sheet.

15. The waterproof construction method of claim 14, further comprising, after the continuous attaching of the waterproof sheets, attaching a waterproof sheet having a predetermined width on an overlap between the waterproof sheets.

16. A waterproof construction method comprising:
coating primer on a surface of a target structure after pre-processing of the surface of the target structure;
preparing a waterproof sheet comprising a released paper attached on one surface of a basic material sheet coated with a solvent-free adhesive manufactured by mixing rubber and tackifier with heated oil in a heat liquefying mixer to form a mixture, and by mixing at least one additive with the mixture;
continuously attaching the waterproof sheets to the surface of the target structure to allow end parts of the waterproof sheets to be smoothly joined to each other after the released paper is removed from the surface of the basic material sheet;
attaching a waterproof sheet having a predetermined width on a joint between the waterproof sheets; and
placing mortar, concrete or protective material for waterproof layer on the upper surface of the waterproof sheet.

17. The waterproof construction method of claim 16, wherein the continuous attaching of the waterproof sheets comprises applying a sealant to an end of the waterproof sheet.
